(19) United States
(12) Patent Application Publication
(10) Pub. No.: US 2026/0078213 A1
(43) Pub. Date: Mar. 19, 2026

(54) METHOD FOR PREPARING AN AMINOSUCCINIC RESIN WITH A LOW AMINE VALUE

(71) Applicant: Arkema France, Colombes (FR)

(72) Inventors: Sylvain BEAUDRAIS, Verneuil En Halatte (FR); Frank COGORDAN, Verneuil En Halatte (FR); Virginie DECOMBLE, Verneuil En Halatte (FR)

(21) Appl. No.: 19/109,181

(22) PCT Filed: Sep. 12, 2023
(86) PCT No.: PCT/EP2023/075060

§ 371 Date: Mar. 6, 2025

(30) Foreign Application Priority Data
Sep. 12, 2022 (FR) FR2209142

(51) Int. Cl. C08G 18/64; C08G 73/02; C09D 175/02

(52) U.S. Cl. CPC C08G 18/6423; C08G 73/0213; C09D 175/02

(57) ABSTRACT

The present invention relates to a process for the preparation of an aminosuccinic resin, and also to the aminosuccinic resin capable of being obtained according to this process, which exhibits an amine value of less than 190 mg KOH/g. Another subject matter of the invention is the use of this aminosuccinic resin in the manufacture of two-component binders containing at least one polyisocyanate.

### SUBJECT MATTER OF THE INVENTION

The present invention relates to a process for the preparation of an aminosuccinic resin, and also to the aminosuccinic resin capable of being obtained according to this process, which exhibits an amine value of less than 190 mg KOH/g. Another subject matter of the invention is the use of this aminosuccinic resin in the manufacture of two-component binders containing at least one polyisocyanate.

### BACKGROUND OF THE INVENTION

Aminosuccinic or aspartic resins are polymers exhibiting —O—C(═O)—CH—CH(NR)—C(═O)—O— units, R being H or alkyl. These units can in particular originate from the addition of a primary or secondary amine to a succinic acid or a derivative of the latter (in particular succinic anhydride or dialkyl succinate). The combination of an aminosuccinic resin with a crosslinking agent, such as a polyisocyanate, makes it possible to obtain extemporaneous formulations of two-component binder. These formulations are of use in the preparation of compositions of adhesives, paints or coatings, in particular for protecting metal surfaces against corrosion, impacts or abrasion. These compositions find applications in particular in the motor vehicle industry, wind turbine industry and construction industry (floor coverings, leaktightness parts, and the like).

Aspartic resins are sold by Covestro under the trade reference Pasquick®. These aspartic resins are prepared from primary diamines sold under the commercial reference Desmophen® and they are capable of reacting with an aliphatic polyisocyanate sold under the commercial reference Desmodur© to form polyureas. Their amine value is at least 190 mg KOH/g.

The document EP 1 516 886 also describes aspartic resins which can be used in the manufacture of binders. These resins are obtained according to a process comprising a first stage of transesterification of a C₁-C₉ alkyl α,β-unsaturated ester, such as a maleic or fumaric acid ester, with a polyol, such as butanediol or a sugar, and a second stage consisting in reacting the product thus obtained with a primary mono- or polyamine, such as cyclohexylamine or 1,6-hexanediamine, under conditions such that primary amine groups no longer remain. The aspartic resins thus obtained exhibit an amine value which is at least 200 mg KOH/g.

The document U.S. Pat. No. 5,925,711 discloses a similar process for the preparation of aspartic resins, except that the oligoester obtained in the first stage is formed either by reaction of an unsaturated diacid, such as maleic or fumaric acid, with a polyol and a monoalcohol, for example 1,6-hexanediol in combination with n-butanol, or by transesterification of a C₁-C₈alkyl diester with a polyol, such as 1,6-hexanediol.

Known aspartic resins make it possible to obtain coating compositions which adhere well to the substrate and the mechanical properties of which are rapidly obtained. However, they are concentrated in amine functions, which implies the use of a large amount of polyisocyanate resin for the formulation of the binders. Given the toxicity and the cost of these polyisocyanate resins, it would thus be desirable to have available reactive diluents having a low amine value. It is also desirable for this property not to be achieved to the detriment of the performance qualities of the composition after application to the substrate, in particular of its Persoz hardness.

### SUMMARY OF THE INVENTION

The inventors have developed a process which makes it possible to satisfy the abovementioned needs, which employs, in the first stage of preparation of the aminosuccinic resin, a light diester transesterified using one or more heavy monoalcohols and optionally one or more polyols. It has been observed that the use of a heavy monoalcohol made it possible to increase the molar mass of the diester and to thus reduce the amine value of the aminosuccinic resin subsequently prepared, without significantly increasing the polydispersity (and thus the viscosity) of the diester thus obtained, and to retain a pot life of the mixture of the resin with a polyisocyanate which is suitable for the envisaged use.

Thus, a subject matter of the present invention is a process for the preparation of an aminosuccinic resin comprising the following stages:
a) the transesterification of at least one alkyl diester of formula (I) using at least one compound A chosen from a monoalcohol of formula (II), a precursor of the latter and their mixtures, and optionally at least one polyol of formula (III):

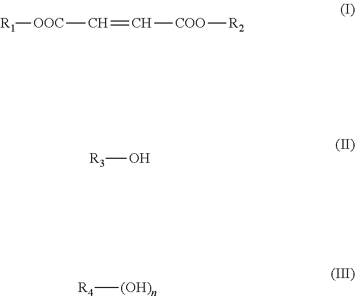

where R₁ and R₂ are independently saturated, linear or branched, hydrocarbon chains which each contain less than 5 carbon atoms; R₃ denotes a saturated or unsaturated, linear, branched or (mono- or poly)cyclic, hydrocarbon chain containing more than 4 carbon atoms;
R₄ denotes a hydrocarbon chain containing at least 2 carbon atoms; and 2 S n 6, in a molar ratio of the compound A to the diester ranging from 0.01 to 1.99,
b) the reaction of the product of this reaction with at least one primary polyamine and optionally at least one primary monoamine, in a molar ratio of the amine functions to the double bonds of the diester ranging from 0.8 to 1.2.

Another subject matter of the invention is an aminosuccinic resin capable of being obtained according to this process and exhibiting an amine value of less than 190 mg KOH/g.

A further subject matter of the invention is the use of this aminosuccinic resin in the manufacture of two-component binders containing at least one polyisocyanate.

Another subject matter of the invention is a binder formulation comprising the abovementioned aminosuccinic resin and a polyisocyanate component.

Another subject matter relates to the use of this binder formulation for obtaining a coating, a mastic or an adhesive, in particular for obtaining a coating, more particularly for obtaining a film, a paint, a varnish, a lacquer, a stain, an adhesion primer or an ink.

Finally, another subject matter of the invention is a coating, an adhesive or a mastic obtained by application and drying of the abovementioned binder formulation.

### DETAILED DESCRIPTION

### Process for the Preparation of an Aminosuccinic Resin

The invention relates to a process for the preparation of an aminosuccinic resin comprising essentially two stages, namely a first stage of transesterification and a second stage of reaction of the product thus obtained with an amine.

### Transesterification

The first stage of this process comprises the transesterification of at least one alkyl diester using at least one compound A chosen from a monoalcohol, a precursor of a monoalcohol and their mixtures, and optionally at least one polyol.

The alkyl diester corresponds to the formula (I):

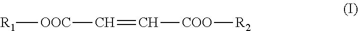

in which R₁ and R₂ are independently saturated, linear or branched, hydrocarbon chains which each contain less than 5 carbon atoms.

Within the meaning of the present invention, the term “hydrocarbon chain” can in particular denote a chain comprising carbon and hydrogen atoms. A hydrocarbon chain can additionally comprise one or more heteroatoms (that is to say, atoms other than carbon and hydrogen), in particular one or more heteroatoms chosen from O, N and S. These heteroatoms can be incorporated inside the chain (i.e. between two carbon atoms) and/or can be incorporated as substituent on the chain. In particular, a hydrocarbon chain can be interrupted with one or more functions chosen from ether, amine, thioether, ester, amide, thioester, carbonate, urea and urethane.

It is preferable for the hydrocarbon chains R₁ and R₂ to be chains consisting solely of carbon or hydrogen atoms. Examples of such diesters (or “light diesters”) are in particular alkyl maleates and fumarates, such as: dimethyl maleate, diethyl maleate, dipropyl maleate, diisopropyl maleate, dibutyl maleate, di(tert-butyl) maleate, diisobutyl maleate, di(sec-butyl) maleate, dimethyl fumarate, diethyl fumarate, dipropyl fumarate, diisopropyl fumarate, dibutyl fumarate, di(tert-butyl) fumarate, diisobutyl fumarate, di(sec-butyl) fumarate, and their mixtures.

For its part, the monoalcohol corresponds to the formula (II):

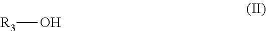

in which R₃ denotes a saturated or unsaturated, linear, branched or (mono- or poly)cyclic, hydrocarbon chain containing more than 4 carbon atoms, preferably more than 9 carbon atoms and generally less than 18 carbon atoms. It is preferable for the hydrocarbon chain R₃ to contain only carbon and hydrogen atoms and to be optionally interrupted and/or substituted by one or more oxygen atoms.

The hydrocarbon chain R₃ is preferentially a (mono- or poly)cyclic hydrocarbon chain, more preferentially a non-aromatic monocyclic hydrocarbon chain. Within the meaning of the invention, a (mono- or poly)cyclic hydrocarbon chain is a chain comprising at least one ring (preferably a non-aromatic ring) and optionally at least one linear or branched non-cyclic chain. The hydrocarbon chain R₃ is preferentially interrupted by one or more ester functions. The hydrocarbon chain R₃ is preferentially devoid of oxyethylene units; more preferentially, the hydrocarbon chain R₃ is devoid of ether functions.

Examples of such alcohols (referred to as “heavy alcohols”) are in particular: pentanol, methylbutanol, dimethylpropanol, hexanol, methylpentanol, ethylbutanol, diethylpropanol, cyclohexanol, heptanol, methylcyclohexanol, octanol, ethylhexanol, nonanol, trimethylcyclohexanol, decanol, tert-butylcyclohexanol, tridecanol, isotridecanol, dodecanol, butoxyethanol, benzyl alcohol, borneol, menthol, tricyclodecylmethanol, methoxy polyethylene glycol, and their mixtures. Particularly preferred heavy alcohols are in particular: cyclohexanol, methylcyclohexanol, trimethylcyclohexanol, tert-butylcyclohexanol, benzyl alcohol, borneol, menthol, tricyclodecylmethanol, and their mixtures.

In one embodiment of the invention, the compound A can comprise a precursor of a monoalcohol, that is to say a compound capable of forming a monoalcohol under the conditions of the transesterification reaction (in particular by ring opening). Use may be made, instead of a monoalcohol of formula (II), of a precursor, that is to say of a compound capable of forming a monoalcohol of formula (II) under the conditions of the transesterification reaction. Said precursor can also be used as a mixture with a monoalcohol. Said precursor can in particular be a lactone, such as γ-butyrolactone, δ-valerolactone or ε-caprolactone or a cyclic diester. A cyclic diester can in particular be a cyclic diester of any α-hydroxylated acid (AHA). In particular, the cyclic diester can be a cyclic dimer of two identical AHAs or a combination of two different AHAs. For example, the cyclic diester can be formed by two glycolic acid molecules, thus giving a glycolide, or of two lactic acid molecules, thus forming a lactide, or of one glycolic acid molecule and of one lactic acid molecule. It is understood that all the isomeric forms of the AHAs can be used to form the cyclic diester. In particular, the cyclic diester can correspond to the following formula (IIa):

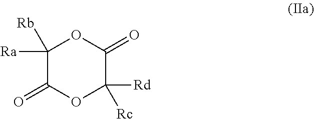

in which Ra, Rb, Rc and Rd are independently chosen from H, methyl or ethyl.

Examples of cyclic diesters are a lactide (Ra and Rc=H and Rb and Rd=methyl) or a glycolide (Ra, Rb, Rc and Rd=H).

According to a preferential embodiment, the compound A corresponds to the formula (IIb):

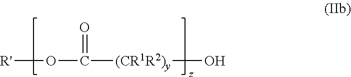

in which:
R′ is a saturated or unsaturated, linear, branched or (mono- or poly)cyclic, hydrocarbon chain containing more than 4 carbon atoms, preferably more than 9 carbon atoms and generally less than 18 carbon atoms,
R¹ and R² are independently chosen from H or an alkyl, preferably H, methyl or ethyl,
y is equal to 1, 2, 3, 4, 5, 6, 7, 8, 9, 10 or 11; preferably, y is equal to 1, 2, 3, 4, 5 or 6, and
z ranges from 0 to 20; preferably, z ranges from 1 to 20.

The hydrocarbon chain R′ is preferentially a (mono- or poly)cyclic hydrocarbon chain, more preferentially a non-aromatic monocyclic hydrocarbon chain. The hydrocarbon chain R′ is preferentially devoid of oxyethylene units; more preferentially, the hydrocarbon chain R′ is devoid of ether functions.

According to a particularly preferred embodiment, the compound A corresponds to the formula (IIb) in which at least one of the following conditions is met:
R′ a is a (mono- or poly)cyclic hydrocarbon chain; preferably, R′ is a non-aromatic monocyclic hydrocarbon chain,
z is greater than 0; preferably, z ranges from 1 to 20.

When z is greater than 0, the compound A can in particular be a monoalcohol resulting from the reaction between a monoalcohol and a precursor of a monoalcohol chosen from a lactone and a cyclic diester.

A polyol can optionally be present in the reaction mixture in order to adjust the rate of increase in viscosity of the varnish obtained from the aminosuccinic resin according to the invention. This polyol corresponds to the formula III

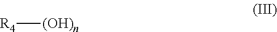

in which:
R₄ denotes a saturated, linear, branched or (mono- or poly)cyclic, hydrocarbon chain containing at least 2 carbon atoms, preferably at least 4 carbon atoms and more preferentially at least 5 carbon atoms, and generally less than 36 carbon atoms, and
2≤n≤6, preferably 2≤n≤3 and more preferentially n is equal to 2.

The hydrocarbon chain R₄ can in particular be interrupted by one or more functions chosen from ether, ester, carbonate, urea and urethane.

It is preferable for the hydrocarbon chain R₄ to contain only carbon and hydrogen atoms and to be optionally interrupted and/or substituted by one or more oxygen atoms. Examples of such polyols are in particular: ethylene glycol, 1,2-propanediol, 1,3-propanediol, 1,4-butanediol, 1,3-butanediol, 1,5-pentanediol, 1,6-hexanediol, 3-methyl-1,5-pentanediol, 1,10-decanediol, 1,12-dodecanediol, diethylene glycol, triethylene glycol, dipropylene glycol, tripropylene glycol, polyalkylene glycols, such as polyethylene glycol or polypropylene glycol (preferably with a number-average molecular weight Mn, calculated from the OH number, ranging from 250 to 3000 g/mol), 1,4-cyclohexanedimethanol, 1,6-cyclohexanedimethanol, 1,4-cyclohexanediol, bisphenol A, hydrogenated bisphenol A, glycerol, diglycerol, tricyclodecanedimethanol, trimethylolpropane, di(trimethylolpropane), trimethylolethane, 1,2,6-hexanetriol, 1,2,4-butanetriol, erythritol, pentaerythritol, di(pentaerythritol), neopentyl glycol, 2-butyl-2-ethyl-1,3-propanediol, 2-methyl-1,3-propanediol, 2-methyl-1,2-propanediol, sorbitol, mannitol, xylitol, isosorbide, isoidide, isomannide, methyl glucoside, polyester polyols (in particular polycaprolactone polyol), polycarbonate polyols, polyorganosiloxane polyols (in particular polydimethysiloxane polyol), polyglycerols, such as glycerol oligomers, for example Polyglycerol-3 (glycerol trimer) and decaglycerol, a hydroxy-terminated polybutadiene, a diol derived from a hydrogenated or nonhydrogenated fatty acid dimer or trimer, alkoxylated (in particular ethoxylated and/or propoxylated) derivatives of the abovementioned polyols, and mixtures of these.

During the transesterification reaction, the molar ratio of the compound A to the diester ranges from 0.01 to 1.99, preferably from 0.1 to 1.5 and more preferentially from 0.2 to 1.0. In the case where a polyol is introduced in this stage, the molar ratio of the polyol to the diester is generally less than 0.6/n, preferably less than 0.4/n and more preferentially less than 0.2/n.

This reaction is generally carried out at a temperature of 50° C. to 300° C., preferably from 80° C. to 250° C. and more preferentially from 150° C. to 200° C. The reaction is generally controlled by measurement of the hydroxyl number of the reaction product, so that the temperature is maintained for a period of time which makes it possible to achieve a hydroxyl number of less than 10 mg KOH/g, preferably of less than 5 mg KOH/g, as measured as described in the examples below.

The transesterification reaction is generally carried out in the presence of a catalyst. The catalyst can, for example, be chosen from oxides and organic salts of metals, such as titanium, tin, zinc, antimony or iron, for example from: titanium(IV) butoxide, tetrakis(2-ethylhexyl) titanate, tin(IV) oxide, dibutyltin oxide, butyltin hydroxide oxide, dibutyltin bis(2-ethylhexyl mercaptoacetate), dibutyltin bis(2-ethylhexanoate), butyl stannoic acid, dibutyltin dichloride, octyltin hydroxide, zinc(IV) oxide and zinc(II) oxide.

It is additionally preferred for the transesterification reaction to be carried out under an inert atmosphere, for example under bubbling with nitrogen.

Reaction with an Amine

On conclusion of the transesterification stage described above, a “heavy” polyester is obtained which is reacted, in the second stage of the process according to the invention, with at least one primary polyamine and optionally at least one primary monoamine, which are denoted together below by “the amine”, unless otherwise indicated. The molar ratio of the amine functions to the double bonds of the diester ranges from 0.8 to 1.2, preferably from 0.9 to 1.1 and more preferentially from 0.95 to 1.05.

The mono- and polyamines used according to the invention can be chosen from amines comprising a saturated or unsaturated (optionally aromatic), linear, cyclic or branched, hydrocarbon chain, to which one or more amino groups are bonded. The polyamine can be chosen from diamines, triamines and tetramines. It is preferably a diamine.

The primary polyamine can in particular correspond to the formula (IV):

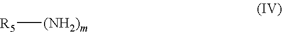

in which:
R₅ is a saturated or unsaturated (optionally aromatic), linear, cyclic or branched, chain comprising at least 2 carbon atoms, preferably at least 4 carbon atoms and more preferentially at least 5 carbon atoms, and generally less than 100 carbon atoms, preferably less than 40 carbon atoms, and
2≤m≤4, preferably 2≤m≤3 and more preferentially m is equal to 2.

It is preferable for the R₅ chain to be a hydrocarbon chain optionally interrupted with one or more heteroatoms independently chosen from oxygen and nitrogen.

According to a particular embodiment, the primary diamine corresponds to the formula (IVa):

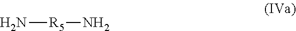

in which R₅ is as defined above.

Examples of diamines can be chosen from: 1-amino-3-aminomethyl-3,5,5-trimethylcyclohexane (IPDA), bis(4-aminocyclohexyl)methane, bis(4-amino-3-methylcyclohexyl)methane, 1,6-diaminohexane, 2-methylpentamethylenediamine, ethylenediamine, 1,2- and 1,3-propanediamines, 2-methyl-1,2-propanediamine, 2,2-dimethyl-1,3-propanediamine, 1,3- and 1,4-butanediamines, 1,3- and 1,5-pentanediamines, 2-methyl-1,5-pentanediamine, 1,6-hexanediamine, 2,5-dimethyl-2,5-hexanediamine, 2,2,4- or 2,4,4-trimethyl-1,6-hexanediamine, 1,7-heptanediamine, 1,8-octanediamine, 1,9-nonanediamine, 1,10-decanediamine, 1,11-undecanediamine, 1,12-dodecanediamine, 2,4- and 2,6-hexahydrotoluylenediamines, 2,4′- and 4,4′-diamino-dicyclohexylmethanes, 1,3- and 1,4-cyclohexanediamines, 1,3- or 1,4-bis(methylamino)cyclohexane, 1,8-p-menthanediamine, hydrazine, phenylenediamine, 2,4- and 2,6-toluylenediamines, 2,3- and 3,4-toluylenediamines, o-, m- or p-xylylenediamines, 2,4′- and 4,4′-diaminodiphenylmethanes, benzidine, and their mixtures. Examples of monoamines are in particular: sec-butylamine, isobutylamine, tert-butylamine, cyclohexylamine, 1,1,3,3-tetramethylbutylamine (or tert-octylamine) and their mixtures.

Examples of triamines are guanidine and N-(2-aminoethyl)-1,3-propanediamine. Mention may in particular be made, as tetramine, of N,N′-di(2-aminoethyl)piperazine.

The primary polyamine can also be a polyetheramine. A polyetheramine is a polyamine comprising ether (—O—) bonds, more particularly ethylene oxide (—O—CH₂—CH₂) and/or propylene oxide (—O—CH₂—CHCH₃—) units.

Examples of polyetheramines are the compounds sold by Huntsman under the Jeffamine® reference, in particular the Jeffamine© D, ED and EDR series. These series include in particular the following references: Jeffamine® D-230, Jeffamine© D-400, Jeffamine® D-2000, Jeffamine® D-4000, Jeffamine© ED-600, Jeffamine® ED-900, Jeffamine® ED-2003, Jeffamine® EDR-148 and Jeffamine® EDR-176.

It has been observed that the use of monoamines alone, which are generally not very bulky, did not make it possible to confer, on the aminosuccinic resin, a sufficient pot life and resulted, after drying of this resin, in flaky and sparingly cohesive films.

The order of introduction of the above reactants is not critical, provided that the monoamines, if they are used, are introduced before the diamines. Generally, the product of the transesterification stage is added slowly to the amine.

The reaction between the amine(s) and the product from the first stage is a Michael reaction, which is generally carried out at a temperature of from 0° C. to 160° C., preferably from 20° C. to 140° C. and more preferentially from 30° C. to 80° C., for a period of time of 1 to 4 hours. It is preferred for this reaction to be carried out under an inert atmosphere, for example under bubbling with nitrogen. The product obtained is generally subsequently maintained at ambient temperature for a period of time of from 15 to 90 days, for example from 30 to 60 days, still under an inert atmosphere.

The two stages described above can be carried out in the presence or the absence of a solvent. Examples of solvents which can be used are polar organic solvents, such as: ketones, in particular acetone, methyl ethyl ketone and methyl isobutyl ketone; esters, such as n-butyl acetate and methoxypropyl acetate; N-methylpyrrolidone; and their mixtures. In an alternative form, use may be made of non-polar organic solvents, such as toluene and xylene.

The amine value of the aminosuccinic resin obtained on conclusion of the second stage described below is less than 190 mg KOH/g, preferably less than 180 mg KOH/g, indeed even less than 150 mg KOH/g, as measured as described in the examples below.

The process according to the invention makes it possible to obtain an aminosuccinic resin.

### Aminosuccinic Resin

The invention also relates to an aminosuccinic resin comprising at least one unit according to the formula (VI):

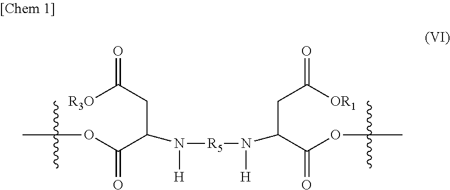

in which:
R₁ is a saturated, linear or branched, hydrocarbon chain which contains less than 5 carbon atoms;
R₃ is a saturated or unsaturated, linear, branched or (mono- or poly)cyclic, hydrocarbon chain containing more than 4 carbon atoms;
R₅ is a saturated or unsaturated (optionally aromatic), linear, cyclic or branched, hydrocarbon chain comprising at least 2 carbon atoms.

According to a particular embodiment, the aminosuccinic resin comprises at least one unit according to the formula (VII):

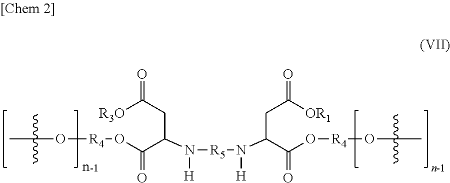

in which R₁, R₃ and R₅ are as defined above;
R₄ is a hydrocarbon chain containing at least 2 carbon atoms as is described in the process according to the invention; and

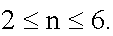

The aminosuccinic resin can in particular be obtained by the process described above.

The R₁, R₃, R₄ and R₅ chains can in particular be as described in the process according to the invention. Thus, in the formulae (VI) and (VII):
R₁ can in particular correspond to the R₁ group which is present on the alkyl diester of formula (I) before the transesterification reaction;
R₃ can in particular correspond to the residue of the compound A of formula (II) or (IIb) (without the OH group) used in the transesterification reaction;
R₄, when it is present, can in particular correspond to the residue of the polyol of formula (III) (without the OH groups) optionally used in the transesterification reaction;
R₅ can in particular correspond to the residue of the primary polyamine of formula (IV) (without the NH₂ groups).

### Binder Formulations

The aminosuccinic resins prepared according to the invention can be used in binder formulations, in combination with a crosslinking agent, such as a polyisocyanate.

Thus, the present invention also relates to a binder formulation comprising:
a) a polyisocyanate component, and
b) a component which is reactive to isocyanates.

This type of formulation is a two-component formulation (also known as 2K formulation). Such a formulation is extemporaneous, that is to say that it is prepared shortly before its application by the final user.

The component b) above comprises the aminosuccinic resin according to the invention and optionally another compound which is reactive to isocyanates. Examples of compounds which are reactive to isocyanates other than the aminosuccinic resin are compounds having one or more functions chosen from alcohol, amine and thiol, preferably diols or diamines or aminoalcohols.

The component a) above comprises a polyisocyanate. The component a) can comprise a mixture of polyisocyanates. Within the meaning of the present invention, a polyisocyanate is a compound having at least 2-NCO functions.

The component a) can in particular comprise an aliphatic or aromatic polyisocyanate, preferably an aliphatic polyisocyanate.

The component a) can in particular comprise a diisocyanate, a dimer or trimer form of a diisocyanate (in particular biuret, allophanate, uretdione or isocyanurate form), a polymer form of a diisocyanate, an elongated form of a diisocyanate (in particular a diisocyanate elongated by reaction with a polyol or a diisocyanate having a carbodiimide group obtained by a decarboxylation reaction between 2 diisocyanate molecules) or a mixture of these.

Examples of suitable polyisocyanates are: 1,4-diisocyanatobutane or tetramethylene diisocyanate, pentamethylene diisocyanate (PDI), 1,6-diisocyanatohexane or hexamethylene diisocyanate (HDI), 1,5-diisocyanato-2,2-dimethylpentane, 2,2,4- or 2,4,4-trimethyl-1,6-diisocyanatohexane, 1,10-diisocyanatodecane, 1,3- or 1,4-diisocyanatocyclohexane, 1-isocyanto-5-isocyanatomethyl-3,3,5-trimethylcyclohexane or isophorone diisocyanate (IDPI), 2,3-, 2,4- or 2,6-diisocyanato-1-methylcyclohexane, 4,4′- or 2,4′-diisocyanatodicyclohexylmethane (H₁₂MDI), 1-isocyanato-3(4)-isocyanatomethyl-1-methylcyclohexane (IMCI), and also the dimer, trimer, polymer and elongated forms of these, and their mixtures. Examples of preferred polyisocyanates are the trimers of HDI, and also the polyisocyanates prepared from 1,6-diisocyanatohexane, which contain isocyanurate groups and optionally uretdione groups. These polyisocyanates generally have an NCO content of from 19% to 24% by weight, with respect to the weight of the polyisocyanate.

These polyisocyanates can optionally be used in combination with polyether-modified polyisocyanates, which can be obtained by reaction of the abovementioned polyisocyanates with an alcohol ether or polyol ether and polyoxyalkylene ether, in particular a polyoxyethylene ether, such as polyethylene glycol monomethyl ether.

Generally, in order to obtain the binder formulations, the aminosuccinic resin and the polyisocyanate are mixed in a molar ratio of the isocyanate groups to the primary amine groups ranging from 0.5:1 to 8:1, preferably from 0.75:1 to 6:1 and more preferentially from 1:1 to 4:1.

These formulations can also comprise other compounds capable of reacting with polyisocyanates, in particular polyacrylates having a hydroxyl function and polyester polyols.

In an alternative form or in addition, they can comprise additives, such as fillers, colorants, thickeners, dispersants, surfactants, sedimentation inhibitors, catalysts, UV stabilizers, antifoaming agents, leveling agents, adhesion promoters, mattifying agents, opacifiers, waxes and their mixtures. They can additionally comprise one or more solvents, chosen, for example, from esters, ketones and aromatic hydrocarbons listed above.

According to a preferred embodiment, the formulation comprises a colorant. A colorant can be chosen from a dye, a pigment and mixtures of these. The term “dye” as used here means a colorant having a solubility of 10 mg/l or more in the medium into which it is introduced at 25° C. The term “pigment” is defined in the standard DIN 55943 as a colorant which is virtually insoluble in the application medium under the ambient conditions which characterize it and the solubility of which is thus less than 10 mg/l in this medium at 25° C.

The colorant can in particular be a pigment. Organic and/or inorganic pigments can be used. If the colorant is not a self-dispersible pigment, the formulations can additionally contain a dispersant, more preferably a polymer dispersant, as described below. The pigment can be chosen from a black, cyan, magenta, yellow, red, orange, violet, blue, green or brown pigment or a mixture of these. The pigment can be chosen from those disclosed by Willy Herbst et al., Industrial Organic Pigments: Production, Properties, Applications, 3rd edition, Wiley—VCH, 2004, ISBN 3527305769.

Examples of particular pigments are described below, the term “C.I.” being used as abbreviation for Colour Index:
carbon black;
C.I. Pigment White 1, 3, 4, 5, 6, 7, 10, 11, 12, 14, 17, 18, 19, 21, 24, 25, 27, 28 and 32;
C.I. Pigment Yellow 1, 3, 10, 12, 13, 14, 17, 55, 65, 73, 74, 75, 83, 93, 97, 109, 111, 120, 128, 138, 139, 150, 151, 154, 155, 180, 185 and 213;
C.I. Pigment Red 17, 22, 23, 41, 48:1, 48:2, 49:1, 49:2, 52:1, 57:1, 81:1, 81:3, 88, 112, 122, 144, 146, 149, 169, 170, 175, 176, 184, 185, 188, 202, 206, 207, 210, 216, 221, 248, 251, 254, 255, 264, 270 and 272;
C.I. Pigment Violet 1, 2, 19, 23, 32, 37 and 3;
C.I. Pigment Blue 15:1, 15:2, 15:3, 15:4, 15:6, 16, 56, 61 and (bridged) aluminum phthalocyanine pigments;
C.I. Pigment Orange 5, 13, 16, 34, 40, 43, 59, 66, 67, 69, 71 and 73;
C.I. Pigment Green 7 and 36;
C.I. Pigment Brown 6 and 7;
and their mixtures.

The formulation can in particular have a Pigment Volume Concentration (PVC) ranging from 3% to 60%, preferably from 5% to 50%, more preferentially from 10% to 40%. The PVC can be defined as an arithmetic quantity corresponding to the percentage of the volume occupied by the pigments with respect to the volume of the whole of the dry film obtained after application and drying of the formulation. The PVC can in particular be measured according to the standard ISO 4618-1:2006.

The formulation can additionally comprise a dispersant. The dispersant can be used to disperse an insoluble material, such as a pigment or a filler, in the formulation.

The dispersant can in particular be a polymer dispersant.

Typical polymer dispersants are copolymers of two, three, four, five or even more monomers. The properties of the polymer dispersants depend both on the nature of the monomers and on their distribution in the polymer. The copolymer dispersants preferably have the following polymer compositions:
random copolymer (for example ABBAABAB);
alternating copolymer (for example ABABABAB);
gradient copolymer (for example, AAABAABBABBB);
block copolymers (for example, AAAAABBBBBB);
grafted copolymers (polymer backbone with polymer side chains attached to the backbone);
and mixed forms of these copolymers.

The polymer dispersant can have a number-average molecular weight Mn of between 500 and 30 000 g/mol, more preferably between 1500 and 10 000 g/mol.

Mention may be made, among the commercial examples of polymer dispersants, of:
the Disperbyk® dispersants available from Byk Chemie GmbH;
the Solsperse® dispersants available from Lubrizol;
the Tego® Dispers dispersants from Evonik;
the Dispex®, Efka® and Joncryl® dispersants from BASF;
the Disponer® dispersants from Elementis.

The binder formulation can be applied to a wide variety of substrates, including wood, metal, stone, plaster, concrete, glass, fabric, leather, paper, a plastic and a composite. The application can be carried out conventionally, in particular by spraying or dipping or using a brush, a roller or a blade. The application can in particular be carried out so as to form one or more layers, preferably having a thickness of from 5 to 100 μm.

The formulation thus obtained is subsequently cured at a temperature of from 20° C. to 100° C.

The binder formulation can in particular be a coating, mastic or adhesive formulation. In particular, the binder formulation can be a coating formulation, more particularly a decorative coating formulation, in particular a film, paint, varnish, lacquer, stain, adhesion primer or ink formulation.

According to a particular embodiment, the binder formulation is a paint, varnish or stain formulation, in particular a finishing paint, varnish or stain formulation. Such a formulation can in particular be applied indoors or outdoors, for example to wood, metal, a wall or plastic.

The formulation can in particular be used to obtain a coating (in particular a film, a paint, a varnish, a lacquer, a stain, an adhesion primer or an ink), an adhesive or a mastic.

Another subject matter of the invention relates to the use of the binder formulation according to the invention in order to obtain a coating (in particular a film, a paint, a varnish, a lacquer, a stain, an adhesion primer or an ink), an adhesive or a mastic.

The invention also relates to a coating (in particular a film, a paint, a varnish, a lacquer, a stain, an adhesion primer or an ink), an adhesive or a mastic obtained by application and drying of the binder formulation according to the invention.

### BRIEF DESCRIPTION OF THE FIGURES

FIG. 1 and FIG. 2 represent examples of processes according to the invention.

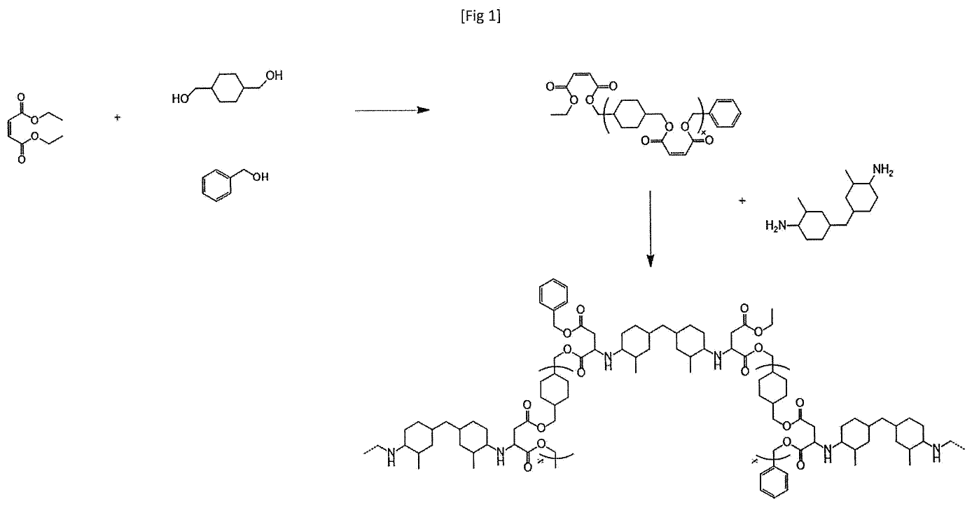

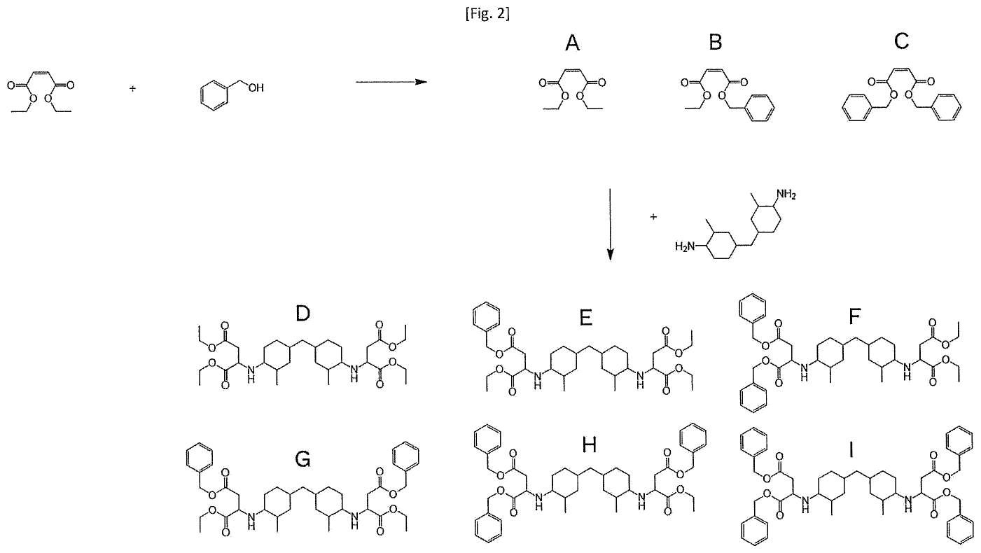

### EXAMPLES

A better understanding of the invention will be obtained in the light of the following examples, which are given purely by way of illustration and do not have the aim of limiting the scope of the invention, defined by the appended claims.

### Examples

### Materials

The materials used in the examples are described below:
DEM (diethyl maleate) from Sigma-Aldrich
D2EHM (di(2-ethylhexyl) maleate) Mw=340 g/mol from Sigma-Aldrich
Butanediol from Sigma-Aldrich
Cyclohexanol from Sigma-Aldrich
Benzyl alcohol from Sigma-Aldrich
TCDDM: Tricyclodecyldimethanol (Mw=196 g/mol) from Sigma-Aldrich
ε-Caprolactone from Sigma-Aldrich
Isotridecanol from BASF
2EH (2-ethylhexanol) from Sigma-Aldrich
TCDOH (tricyclodecylmethanol) from Oxea
CHDM (cyclohexanedimethanol) from Sigma-Aldrich
NPG (neopentyl glycol) from Sigma-Aldrich
MBMCHA (4,4′-methylenebis(2-methylcyclohexylamine)) from TC
MBCHA (4,4′-methylenebis(cyclohexylamine)) from Sigma Aldrich
CHA (cyclohexylamine) from Sigma-Aldrich
Fascat 4100 (butylstannoic acid) from Brenntag

### Measurement Methods

### Amine Value

The amine value is measured by quantitative determination with a Metrohm (848 Titrino Plus) titrimeter equipped with a Metrohm reference 6.0262.100 measurement probe. The sample to be analyzed is weighed in a 100 ml beaker. 50 ml of dichloromethane are added. The sample is completely dissolved by magnetic stirring. Titration is carried out under magnetic stirring with 0.1N perchloric acid in acetic acid, according to the chosen method of use of the titrimeter. The amine value is calculated according to the following equation:

$${V}_{Amine} ( mgKOH / g ) = \frac{VS \times NT \times 56.1}{W} \qquad [ Chem 3 ]$$

VS=Volume of titrant added for the quantitative determination of the sample (ml)
NT=Normality of the titrant (0.1N)
W=Weight of the sample (g).

### Hydroxyl Value

The hydroxyl value is measured by quantitative determination with a Metrohm (848 Titrino Plus) titrimeter equipped with a Metrohm reference 6.0229.100 measurement probe. An acid-base back titration of the excess acetic anhydride with respect to the hydroxyl functions is carried out under the following conditions: the product, of exact weight W (approximately 3 grams), is dissolved in exactly 10 ml of acetylating solution (mixture of 555 ml of ethyl acetate, 60 ml of acetic anhydride and 7 g of para-toluenesulfonic acid monohydrate). The mixture is left to react at 90° C. for 30 minutes. After cooling, approximately 2 ml of water are added and the mixture is left to react at ambient temperature for 2 minutes. Approximately 10 ml of hydrolyzing solution (mixture of 600 ml of pyridine and 400 ml of water) are then added and the mixture is left to react at ambient temperature for 5 minutes. Approximately 60 ml of solvent (mixture of 666 ml of n-butanol and 333 ml of toluene) are added. Subsequently, the excess of acetic acid (released by the hydrolysis of the acetic anhydride in excess with respect to the hydroxyl functions to be acetylated) is quantitatively determined with methanolic potassium hydroxide of exact normal titer N (Eq/l) of approximately 0.5N, according to the chosen method of use of the titrimeter. A blank test (identical to the protocol above without the product to be analyzed) is also carried out. The hydroxyl value is calculated according to the following equation:

$${V}_{OH} ( mgKOH / g ) = {V}_{Acid} + \frac{( VS - VB ) \times NT \times 56.1}{W}$$

with
VS=Volume of titrant added for the quantitative determination of the sample (ml)
VB=Volume of the blank test
NT=Normality of the titrant (0.5N)
W=Weight of the sample (g)
V_{Acid}=Acid value determined according to the method below.

### Acid Value

The acid value is measured by quantitative determination with a Metrohm (848 Titrino Plus) titrimeter equipped with a Metrohm reference 6.0229.100 measurement probe. The sample to be analyzed is weighed in a 100 ml beaker. 50 ml of solvent (mixture of 500 ml of toluene and 500 ml of methanol) are added. The sample is completely dissolved by magnetic stirring. Titration is carried out under magnetic stirring with 0.1N methanolic potassium hydroxide, according to the chosen method of use of the titrimeter. The acid value is calculated according to the following equation:

$${V}_{Acid} ( mgKOH / g ) = \frac{VS \times NT \times 56.1}{W}$$

with
VS=Volume of titrant added for the quantitative determination of the sample (ml)
NT=Normality of the titrant (0.1N)
W=Weight of the sample (g).

### Measurement of the Viscosity of the Varnish

The initial viscosity of the varnish before application is measured on a Brookfield CAP 1000 viscometer (high shear gradient) according to the standard ISO 2884, with a cone 2 or 3 depending on the initial viscosity of the polyaminosuccinic, at 25° C.

### Pot Life

The pot life is the time needed to observe a doubling of the initial viscosity of a varnish composition. The viscosity is measured regularly over time. The combined measurements make it possible to plot a straight line which makes it possible to calculate the pot life of the composition by linear regression. This common measurement makes it possible to know about the ideal range of use of the composition without losing applicative properties.

### Dry Thickness of the Varnish

The dry thickness is measured on a dry film of varnish 24 hours after application (according to the standard NF EN ISO 2808) with a film applicator of a varnish composition with a thickness of 150 μm wet (50 μm dry) on a QD46 steel plate (in a room climate controlled at 23° C. and 50% relative humidity).

### Persoz Hardness of the Varnish

The Persoz hardness is measured according to the standard NF EN ISO 1522 of March 2007 after application with a film applicator of a varnish composition with a thickness of 150 μm wet (50 μm dry) on a QD46 steel plate (in a room climate controlled at 23° C. and 50% relative humidity).

The Persoz hardness is measured 24 h or 14 days after application of the varnish (in a room climate controlled at 23° C. and 50% relative humidity).

### Example 1 (Transesterification)

DEM (344.00 g, i.e. 2.000 mol), isotridecanol (119.40 g, i.e. 0.597 mol), CHDM (7.40 g, i.e. 0.050 mol) and Fascat 4100 (0.050 g) were introduced into a reactor equipped with a distillation column, with a thermometer, with a dip pipe for bubbling nitrogen and with a stirrer having inclined blades. Bubbling with nitrogen at 30 ml/minute is applied throughout the synthesis. The temperature is brought to and then maintained at 170° C. The ethanol formed during the transesterification reaction is distilled off. The temperature is maintained until a hydroxyl value of less than 5 mg KOH/g is obtained. The heavy maleate polyester obtained is colorless.

### Example 2 (Transesterification)

DEM (454.18 g, i.e. 2.641 mol), 2EH (118.56 g, i.e. 0.912 mol), CHDM (4.75 g, i.e. 0.033 mol) and Fascat 4100 (0.055 g) were introduced into a reactor equipped with a distillation column, with a thermometer, with a dip pipe for bubbling nitrogen and with a stirrer having inclined blades. Bubbling with nitrogen at 30 ml/minute is applied throughout the synthesis. The temperature is brought to and then maintained at 190° C. The ethanol formed during the transesterification reaction is distilled off. The temperature is maintained until a hydroxyl value of less than 10 mg KOH/g is obtained. The heavy maleate polyester obtained is colorless. The hydroxyl value, measured after cooling, is 7.5 mg KOH/g.

### Example 3 (Transesterification)

DEM (456.76 g, i.e. 2.656 mol), 2EH (111.18 g, i.e. 0.855 mol), CHDM (9.56 g, i.e. 0.066 mol) and Fascat 4100 (0.055 g) were introduced into a reactor equipped with a distillation column, with a thermometer, with a dip pipe for bubbling nitrogen and with a stirrer having inclined blades. Bubbling with nitrogen at 30 ml/minute is applied throughout the synthesis. The temperature is brought to and then maintained at 190° C. The ethanol formed during the transesterification reaction is distilled off. The temperature is maintained until a hydroxyl value of less than 10 mg KOH/g is obtained. The heavy maleate polyester obtained is colorless. The hydroxyl value, measured after cooling, is 6.9 mg KOH/g.

### Example 4 (Transesterification)

DEM (166.65 g, i.e. 0.969 mol), TCDOH (160.83 g, i.e. 0.821 mol), NPG (2.52 g, i.e. 0.024 mol) and Fascat 4100 (0.040 g) were introduced into a reactor equipped with a distillation column, with a thermometer, with a dip pipe for bubbling nitrogen and with a stirrer having inclined blades. Bubbling with nitrogen at 30 ml/minute is applied throughout the synthesis. The temperature is brought to and then maintained at 190° C. The ethanol formed during the transesterification reaction is distilled off. The temperature is maintained until a hydroxyl value of less than 5 mg KOH/g is obtained. The heavy maleate polyester obtained is colorless. The hydroxyl value, measured after cooling, is 2.1 mg KOH/g.

### Example 5 (Transesterification)

DEM (425.70 g, i.e. 2.475 mol), isotridecanol (147.45 g, i.e. 0.737 mol), NPG (6.68 g, i.e. 0.064 mol) and Fascat 4100 (0.100 g) were introduced into a reactor equipped with a distillation column, with a thermometer, with a dip pipe for bubbling nitrogen and with a stirrer having inclined blades. Bubbling with nitrogen at 30 ml/minute is applied throughout the synthesis. The temperature is brought to and then maintained at 160° C. The ethanol formed during the transesterification reaction is distilled off. The temperature is maintained until a hydroxyl value of less than 5 mg KOH/g is obtained. The heavy maleate polyester obtained is colorless. The hydroxyl value, measured after cooling, is 4.2 mg KOH/g.

### Example 6 (Aminosuccinic Resin)

MBMCHA (51.87 g) is introduced into a reactor equipped with a reflux column, with a dip pipe for bubbling nitrogen, with a thermometer, with a dropping funnel and with a stirrer having inclined blades. Bubbling with nitrogen at 30 ml/minute is applied throughout the synthesis. 98.13 g of the product obtained in example 1 are introduced into the dropping funnel and then added over a period of 1 hour while keeping the temperature below 50° C. The temperature is maintained at 50° C. for a further 1 hour and then the contents of the reactor are transferred into an inert flask and kept closed at ambient temperature for 60 days. The reduction in the area under the peaks corresponding to the ethylenic protons (between 6.8 and 6.9 ppm) is monitored by ¹H NMR. The theoretical solids content of the finished product is 100%. The amine value measured after storage is 163 mg KOH/g.

### Example 7 (Aminosuccinic Resin)

MBMCHA (35.44 g) and CHA (1.55 g) are introduced into a reactor equipped with a reflux column, with a dip pipe for bubbling nitrogen, with a thermometer, with a dropping funnel and with a stirrer having inclined blades. Bubbling with nitrogen at 30 ml/minute is applied throughout the synthesis. 63.01 g of the product obtained in example 2 are introduced into the dropping funnel and then added over a period of 1 hour while keeping the temperature below 50° C. The temperature is maintained at 50° C. for a further 1 hour and then the contents of the reactor are transferred into an inert flask and kept closed at ambient temperature for 30 days. The reduction in the area under the peaks corresponding to the ethylenic protons (between 6.8 and 6.9 ppm) is monitored by ¹H NMR. The theoretical solids content of the finished product is 100%. The amine value measured after storage is 176 mg KOH/g.

### Example 8 (Aminosuccinic Resin)

MBMCHA (37.19 g) is introduced into a reactor equipped with a reflux column, with a dip pipe for bubbling nitrogen, with a thermometer, with a dropping funnel and with a stirrer having inclined blades. Bubbling with nitrogen at 30 ml/minute is applied throughout the synthesis. 62.81 g of the product obtained in example 3 are introduced into the dropping funnel and then added over a period of 1 hour while keeping the temperature below 50° C. The temperature is maintained at 50° C. for a further 1 hour and then the contents of the reactor are transferred into an inert flask and kept closed at ambient temperature for 30 days. The reduction in the area under the peaks corresponding to the ethylenic protons (between 6.8 and 6.9 ppm) is monitored by 1H NMR. The theoretical solids content of the finished product is 100%. The amine value measured after storage is 175 mg KOH/g.

### Example 9 (Aminosuccinic Resin)

MBMCHA (57.92 g) is introduced into a reactor equipped with a reflux column, with a dip pipe for bubbling nitrogen, with a thermometer, with a dropping funnel and with a stirrer having inclined blades. Bubbling with nitrogen at 30 ml/minute is applied throughout the synthesis. 142.08 g of the product obtained in example 4 are introduced into the dropping funnel and then added over a period of 1 hour while keeping the temperature below 50° C. The temperature is maintained at 50° C. for a further 1 hour and then the contents of the reactor are transferred into an inert flask and kept closed at ambient temperature for 60 days. The reduction in the area under the peaks corresponding to the ethylenic protons (between 6.8 and 6.9 ppm) is monitored by ¹H NMR. The theoretical solids content of the finished product is 100%. The amine value measured after storage is 137 mg KOH/g.

### Example 10 (Aminosuccinic Resin)

MBCHA (36.55 g) is introduced into a reactor equipped with a reflux column, with a dip pipe for bubbling nitrogen, with a thermometer, with a dropping funnel and with a stirrer having inclined blades. Bubbling with nitrogen at 30 ml/minute is applied throughout the synthesis. 75.95 g of the product obtained in example 5 are introduced into the dropping funnel and then added over a period of 2 hours while keeping the temperature below 50° C. The temperature is maintained at 50° C. for a further 1 hour and then the contents of the reactor are transferred into an inert flask and kept closed at ambient temperature for 30 days. The reduction in the area under the peaks corresponding to the ethylenic protons (between 6.8 and 6.9 ppm) is monitored by ¹H NMR. The theoretical solids content of the finished product is 100%. The amine value measured after storage is 174 mg KOH/g.

### Example 11 (Aminosuccinic Resin)

76.09 g of the product obtained in example 5 are introduced into a reactor equipped with a reflux column, with a dip pipe for bubbling nitrogen, with a thermometer, with a dropping funnel and with a stirrer having inclined blades. Bubbling with nitrogen at 30 ml/minute is applied throughout the synthesis. 3.45 g of CHA are added. The temperature is brought to and then maintained at 50° C. for 1 hour. 32.96 g of MBCHA are introduced into the dropping funnel and then added over a period of 1 hour 30 min while keeping the temperature below 50° C. The contents of the reactor are transferred into an inert flask and kept closed at ambient temperature for 30 days. The reduction in the area under the peaks corresponding to the ethylenic protons (between 6.8 and 6.9 ppm) is monitored by 1H NMR. The theoretical solids content of the finished product is 100%. The amine value measured after storage is 174 mg KOH/g.

### Comparative Example 1 (Use of a Heavy Diester without Transesterification)

75.00 g of D2EHM (0.2206 mol) are introduced into a reactor equipped with a reflux column, with a dip pipe for bubbling nitrogen, with a thermometer, with a dropping funnel and with a stirrer having inclined blades. Bubbling with nitrogen at 30 ml/minute is applied throughout the synthesis. 26.25 g of MBMCHA (0.1103 mol) are introduced into the dropping funnel and then added over a period of 1 h while keeping the temperature below 50° C. The contents of the reactor are transferred into an inert flask and kept closed at ambient temperature for 30 days. The reduction in the area under the peaks corresponding to the ethylenic protons (between 6.8 and 6.9 ppm) is monitored by 1H NMR. The theoretical solids content of the finished product is 100%. The amine value measured after storage is 122 mg KOH/g.

### Comparative Example 2 (Transesterification without Heavy Monoalcohol)

DEM (420.31 g, i.e. 2.4437 mol), butanediol (38.33 g, i.e. 0.4259 mol) and Fascat 4100 (0.100 g) were introduced into a reactor equipped with a distillation column, with a thermometer, with a dip pipe for bubbling nitrogen and with a stirrer having inclined blades. Bubbling with nitrogen at 30 ml/minute is applied throughout the synthesis. The temperature is brought to and then maintained at 170° C. The ethanol formed during the transesterification reaction is distilled off. The temperature is maintained until a hydroxyl value of less than 5 mg KOH/g is obtained.

59.06 g of the product obtained are introduced into a reactor equipped with a reflux column, with a dip pipe for bubbling nitrogen, with a thermometer, with a dropping funnel and with a stirrer having inclined blades. Bubbling with nitrogen at 30 ml/minute is applied throughout the synthesis. 40.94 g of MBMCHA are introduced into the dropping funnel and then added over a period of 30 min while keeping the temperature below 50° C. The contents of the reactor are transferred into an inert flask and kept closed at ambient temperature for 30 days. The reduction in the area under the peaks corresponding to the ethylenic protons (between 6.8 and 6.9 ppm) is monitored by ¹H NMR. The theoretical solids content of the finished product is 100%. The amine value measured after storage is 193 mg KOH/g.

### Comparative Example 3 (Transesterification without Heavy Monoalcohol)

DEM (420.31 g, i.e. 2.4437 mol), butanediol (54.98 g, i.e. 0.6109 mol) and Fascat 4100 (0.100 g) were introduced into a reactor equipped with a distillation column, with a thermometer, with a dip pipe for bubbling nitrogen and with a stirrer having inclined blades. Bubbling with nitrogen at 30 ml/minute is applied throughout the synthesis. The temperature is brought to and then maintained at 170° C. The ethanol formed during the transesterification reaction is distilled off. The temperature is maintained until a hydroxyl value of less than 5 mg KOH/g is obtained.

59.04 g of the product obtained are introduced into a reactor equipped with a reflux column, with a dip pipe for bubbling nitrogen, with a thermometer, with a dropping funnel and with a stirrer having inclined blades. Bubbling with nitrogen at 30 ml/minute is applied throughout the synthesis. 40.96 g of MBMCHA are introduced into the dropping funnel and then added over a period of 30 min while keeping the temperature below 50° C. The contents of the reactor are transferred into an inert flask and kept closed at ambient temperature for 30 days. The reduction in the area under the peaks corresponding to the ethylenic protons (between 6.8 and 6.9 ppm) is monitored by ¹H NMR. The theoretical solids content of the finished product is 100%. The amine value measured after storage is 193 mg KOH/g.

### Example 12 (Transesterification with Heavy Monoalcohol)

DEM (420.31 g, i.e. 2.4437 mol), benzyl alcohol (131.95 g, i.e. 1.2218 mol) and Fascat 4100 (0.100 g) were introduced into a reactor equipped with a distillation column, with a thermometer, with a dip pipe for bubbling nitrogen and with a stirrer having inclined blades. Bubbling with nitrogen at 30 ml/minute is applied throughout the synthesis. The temperature is brought to and then maintained at 170° C. The ethanol formed during the transesterification reaction is distilled off. The temperature is maintained until a hydroxyl value of less than 5 mg KOH/g is obtained.

63.04 g of the product obtained are introduced into a reactor equipped with a reflux column, with a dip pipe for bubbling nitrogen, with a thermometer, with a dropping funnel and with a stirrer having inclined blades. Bubbling with nitrogen at 30 ml/minute is applied throughout the synthesis. 36.96 g of MBMCHA are introduced into the dropping funnel and then added over a period of 30 min while keeping the temperature below 50° C. The contents of the reactor are transferred into an inert flask and kept closed at ambient temperature for 30 days. The reduction in the area under the peaks corresponding to the ethylenic protons (between 6.8 and 6.9 ppm) is monitored by 1H NMR. The theoretical solids content of the finished product is 100%. The amine value measured after storage is 174 mg KOH/g.

### Example 13 (Transesterification with Monofunctional Heavy Monoalcohol and Heavy Monoalcohol Precursor)

DEM (363.01 g, i.e. 2.1105 mol), TCDDM (5.17 g, i.e. 0.0264 mol), cyclohexanol (150.00 g, i.e. 1.5000 mol), F-caprolactone (91.43 g, i.e. 0.8020 mol) and Fascat 4100 (0.100 g) were introduced into a reactor equipped with a distillation column, with a thermometer, with a dip pipe for bubbling nitrogen and with a stirrer having inclined blades. Bubbling with nitrogen at 30 ml/minute is applied throughout the synthesis. The temperature is brought to and then maintained at 170° C. The ethanol formed during the transesterification reaction is distilled off. The temperature is maintained until a hydroxyl value of less than 5 mg KOH/g is obtained.

68.18 g of the product obtained are introduced into a reactor equipped with a reflux column, with a dip pipe for bubbling nitrogen, with a thermometer, with a dropping funnel and with a stirrer having inclined blades. Bubbling with nitrogen at 30 ml/minute is applied throughout the synthesis. 31.82 g of MBMCHA are introduced into the dropping funnel and then added over a period of 30 min while keeping the temperature below 50° C. The contents of the reactor are transferred into an inert flask and kept closed at ambient temperature for 30 days. The reduction in the area under the peaks corresponding to the ethylenic protons (between 6.8 and 6.9 ppm) is monitored by 1H NMR. The theoretical solids content of the finished product is 100%. The amine value measured after storage is 150 mg KOH/g.

### Example 14: Applicative Properties

Several resins according to the invention and comparative resins, prepared as described above, and also the resins according to the prior art mentioned below, were tested in order to evaluate the proportion of polyisocyanate necessary to obtain a varnish. Various properties of this varnish were also evaluated, namely its viscosity before application, its pot life, its dry thickness and its Persoz hardness at 24 h and 14 days, according to the protocols described above.

The Resins According to the Prior Art were as Follows:
Comparative example 4—Synocure 9226 BA 82: Hydroxylated acrylic resin with a high solids content having a V_{OH} of 5.4%, with respect to the bulk resin, with a viscosity of 3000-5000 mPa·s at 25° C. and a solids content of 82% in butyl acetate.
Comparative example 5—Desmophen NH1420: Aminosuccinic resin having an amine value of 201 mg KOH/g, with respect to the bulk resin, with a viscosity of 1000 mPa·s at 25° C. and a solids content of 100%.
Comparative example 6—Desmophen NH1520: Aminosuccinic resin having an amine value of 191 mg KOH/g, with respect to the bulk resin, with a viscosity of 1400 mPa·s at 25° C. and a solids content of 100%.

### Operating Conditions for Formulation of the Two-Component Varnish:

The formulations of the two-component varnishes are produced with a stoichiometric amine/NCO ratio for the aminosuccinic resins and a stoichiometric OH/NCO ratio for the polyacrylics, are adjusted to a solids content of 75% by volume, and have a VOC value of 220 g/l.

The isocyanate used in this two-component system is Tolonate™ HDT-LV2, which is a solvent-free hexamethylene diisocyanate trimer of low viscosity, having an NCO content of 23%, sold by Vencorex.

### For the Aminosuccinic Resins:

The aminosuccinic resin is incorporated in a suitable container, followed by the solvent (butyl acetate) and then by the isocyanate.

The two-component varnish is stirred in a sustained manner for 30 seconds with a spatula and then it is left to stand for one minute for debubbling before measuring its viscosity and applying it.

### For the Polyacrylics:

The polyacrylic resin is incorporated in a suitable container, followed by 0.5% (dry on resin) of catalyst of dibutyltin dilaurate (DBTDL) type, solvent (butyl acetate) and then the isocyanate. The two-component varnish is stirred in a sustained manner for 30 seconds with a spatula and then it is left to stand for one minute for debubbling before measuring its viscosity and applying it.

### Applicative Results:

TABLE 1

| | | Amine | | Viscosity of the | | | Persoz | Persoz |
|---|---|---|---|---|---|---|---|---|
| | Solids | value on | | varnish before | | Dry | hardness | hardness |
| | content | dry resin | Resin:polyisocyanate | application at | Pot life | thickness | at 24 h | at 14 |
| Resin | (%) | (mg KOH/g) | ratio by weight | (25° C. mPa · s) | (min) | (μm) | (s) | days (s) |
| Comp. 4 | 82 | — | — | 555 | 42 | 46 | 58 | 240 |
| Comp. 5 | 100 | 201 | 1:0.65 | 65 | 5 | 52 | 301 | 308 |
| Ex. 10 | 100 | 174 | 1:0.56 | 85 | 5 | 52 | 276 | 294 |
| Ex. 11 | 100 | 174 | 1:0.56 | 65 | 5 | 51 | 284 | 304 |

TABLE 2

| | | | | Viscosity of the | | | Persoz | Persoz |
|---|---|---|---|---|---|---|---|---|
| | Solids | Amine value | | varnish before | | Dry | hardness | hardness |
| | content | on dry resin | Resin:polyisocyanate | application at | Pot life | thickness | at 24 h | on day |
| Resin | (%) | (mg KOH/g) | ratio by weight | 25° C. (mPa · s) | (min) | (μm) | (s) | 14 (s) |
| Comp. 4 | 82 | — | — | 555 | 42 | 46 | 58 | 240 |
| Comp. 6 | 100 | 191 | 1:0.62 | 65 | 90 | 52 | 217 | 360 |
| Ex. 6 | 100 | 163 | 1:0.53 | 79 | 56 | 43 | 93 | 307 |
| Ex. 7 | 100 | 176 | 1:0.57 | 105 | 39 | 49 | 85 | 320 |
| Ex. 8 | 100 | 175 | 1:0.57 | 118 | 51 | 50 | 88 | 320 |
| Ex. 9 | 100 | 137 | 1:0.44 | 293 | 39 | 52 | 252 | 361 |
| Comp. 1 | 100 | 122 | 1:0.40 | 200 | 212 | 51 | TACKY | 60 |
| | | | | | | | FILM | |

Tables 1 and 2 above show that the varnishes obtained starting from the resins according to the invention exhibit acceptable hardnesses at 14 days, viscosities and pot lives, with a lower consumption of polyisocyanate compared with the comparative tests.

Comparative example 1 shows that the direct use of a heavy diester without a transesterification phase gives a tacky film at 24 h and an insufficiently cured film at 14 days.

TABLE 3

| | | Amine | | Viscosity of the | | | OH/maleic | Persoz |
|---|---|---|---|---|---|---|---|---|
| | Solids | value on | | varnish before | | Dry | ester | hardness |
| | content | dry resin | Resin:polyisocyanate | application at | Pot life | thickness | molar | at 7 days |
| Resin | (%) | (mg KOH/g) | ratio by weight | 25° C. (mPa · s) | (min) | (μm) | ratio | (s) |
| Comp. 2 | 100 | 193 | 1:0.63 | 88 | 75 | 48 | 0.174 | 342 |
| Comp. 3 | 100 | 193 | 1:0.63 | 163 | 75 | 43 | 0.250 | 340 |
| Ex. 12 | 100 | 174 | 1:0.56 | 51 | 120 | 43 | 0.250 | 317 |
| Ex. 13 | 100 | 150 | 1:0.49 | 159 | 62 | 49 | 0.355 | 238 |

Comparative examples 2 and 3 show the impact of the increase in the amount of polyol on the initial viscosity of the formulation.

This table also shows that, for an identical OH/maleic ester ratio, the resin according to the invention (example 12) exhibits a lower V_{NH} than the resin of comparative example 3. The varnish obtained additionally exhibits a lower viscosity (implying the possibility of using a smaller amount of solvent), a longer pot life and a hardness at 1 week which is virtually equivalent to those of the comparative varnish.

Example 13 shows that excellent compromises between V_{NH} (low) and hardness (rather high) can be obtained with precursors of primary alcohols (caprolactone).

1. A process for the preparation of an aminosuccinic resin comprising the stages:
a) transesterification of at least one alkyl diester of formula (I) using at least one compound A chosen from a monoalcohol of formula (II), a precursor of the monoalcohol of formula (II) and their mixtures, and optionally at least one polyol of formula (III): 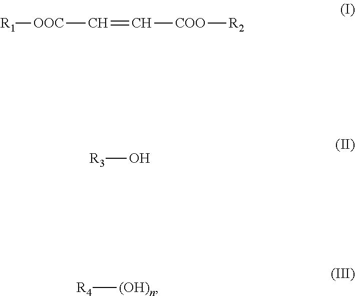
where:
R₁ and R₂ are independently saturated, linear or branched, hydrocarbon chains, and each of R₁ and R₂ contains less than 5 carbon atoms;
R₃ denotes a saturated or unsaturated, linear, branched or (mono- or poly)cyclic, hydrocarbon chain containing more than 4 carbon atoms;
R₄ denotes a hydrocarbon chain containing at least 2 carbon atoms; and
2≤n≤6, and
wherein a molar ratio of the compound A to the at least one alkyl diester ranges from 0.01 to 1.99, and
b) reaction of a transesterification product of the at least one alkyl diester and the at least one compound A with at least one primary polyamine and optionally at least one primary monoamine, wherein a molar ratio of the amine functional groups of the at least one primary polyamine and optionally at least one primary monoamine to the double bonds of the at least one alkyl diester ranges from 0.8 to 1.2.

2. The process as claimed in claim 1, characterized in that the alkyl diester is chosen from: alkyl maleates and fumarates.

3. The process as claimed in claim 1, characterized in that the compound A is a monoalcohol chosen from: cyclohexanol, methylcyclohexanol, trimethylcyclohexanol, tert-butylcyclohexanol, benzyl alcohol, borneol, menthol, tricyclodecylmethanol, and their mixtures.

4. The process as claimed in claim 1, characterized in that the compound A corresponds to formula (IIb): 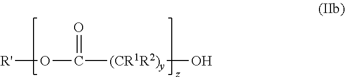
in which:
R′ is a saturated or unsaturated, linear, branched or (mono- or poly)cyclic, hydrocarbon chain containing more than 4 carbon atoms and less than 18 carbon atoms,
R¹ and R² are independently chosen from H or an alkyl,
y is equal to 1, 2, 3, 4, 5, 6, 7, 8, 9, 10 or 11, and
z ranges from 0 to 20.

5. The process as claimed in claim 4, characterized in that the compound A corresponds to formula (IIb) in which at least one of the following conditions is met:
R′ is a (mono- or poly)cyclic hydrocarbon chain;
z is greater than 0.

6. The process as claimed in claim 1,
characterized in that the polyol is chosen from: ethylene glycol, 1,2-propanediol, 1,3-propanediol, 1,4-butanediol, 1,3-butanediol, 1,5-pentanediol, 1,6-hexanediol, 3-methyl-1,5-pentanediol, 1,10-decanediol, 1,12-dodecanediol, diethylene glycol, triethylene glycol, dipropylene glycol, tripropylene glycol, polyalkylene glycols, 1,4-cyclohexanedimethanol, 1,6-cyclohexanedimethanol, 1,4-cyclohexanediol, bisphenol A, hydrogenated bisphenol A, glycerol, diglycerol, tricyclodecanedimethanol, trimethylolpropane, di(trimethylolpropane), trimethylolethane, 1,2,6-hexanetriol, 1,2,4-butanetriol, erythritol, pentaerythritol, di(pentaerythritol), neopentyl glycol, 2-butyl-2-ethyl-1,3-propanediol, 2-methyl-1,3-propanediol, 2-methyl-1,2-propanediol, sorbitol, mannitol, xylitol, isosorbide, isoidide, isomannide, methyl glucoside, polyester polyols, polycarbonate polyols, polyorganosiloxane polyols, polyglycerols, a hydroxy-terminated polybutadiene, a diol derived from a hydrogenated or nonhydrogenated fatty acid dimer or trimer, alkoxylated derivatives of the polyols, and mixtures thereof.

7. The process as claimed in claim 1, characterized in that a molar ratio of the polyol to the at least one alkyl diester is less than 0.6/n.

8. The process as claimed in claim 1, characterized in that the polyamine is a diamine chosen from: 1-amino-3-aminomethyl-3,5,5-trimethylcyclohexane (IPDA), bis(4-aminocyclohexyl)methane, bis(4-amino-3-methylcyclohexyl)methane, 1,6-diaminohexane, 2-methylpentamethylenediamine, ethylenediamine, 1,2- and 1,3-propanediamines, 2-methyl-1,2-propanediamine, 2,2-dimethyl-1,3-propanediamine, 1,3- and 1,4-butanediamines, 1,3- and 1,5-pentanediamines, 2-methyl-1,5-pentanediamine, 1,6-hexanediamine, 2,5-dimethyl-2,5-hexanediamine, 2,2,4- or 2,4,4-trimethyl-1,6-hexanediamine, 1,7-heptanediamine, 1,8-octanediamine, 1,9-nonanediamine, 1,10-decanediamine, 1,11-undecanediamine, 1,12-dodecanediamine, 2,4- and 2,6-hexahydrotoluylenediamines, 2,4′- and 4,4′-diamino-dicyclohexylmethanes, 1,3- and 1,4-cyclohexanediamines, 1,3- or 1,4-bis(methylamino)cyclohexane, 1,8-p-menthanediamine, hydrazine, phenylenediamine, 2,4- and 2,6-toluylenediamines, 2,3- and 3,4-toluylenediamines, o-, m- or p-xylylenediamines, 2,4′- and 4,4′-diaminodiphenylmethanes, benzidine and their mixtures.

9. The process as claimed in claim 1, characterized in that the monoamine is chosen from: sec-butylamine, isobutylamine, tert-butylamine, cyclohexylamine, 1,1,3,3-tetramethylbutylamine (or tert-octylamine) and their mixtures.

10. An aminosuccinic resin obtained according to the process as claimed in claim 1 and exhibiting an amine value of less than 190 mg KOH/g.

11. An aminosuccinic resin comprising at least one unit according to formula (VI): 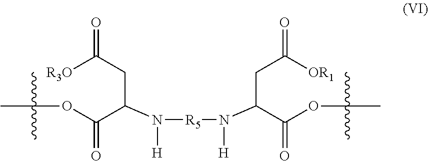
in which:
R₁ is a saturated, linear or branched, hydrocarbon chain which contains less than 5 carbon atoms;
R₃ is a saturated or unsaturated, linear, branched or (mono- or poly)cyclic, hydrocarbon chain containing more than 4 carbon atoms; and
R₅ is the residue of a primary polyamine.

12. The aminosuccinic resin as claimed in claim 11, characterized in that it comprises at least one unit according to the formula (VII): 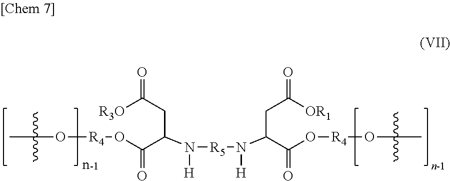
in which:
R₄ is a hydrocarbon chain containing at least 2 carbon atoms; and
$$2 \leq n \leq 6 .$$

13. (canceled)

14. A binder formulation comprising the aminosuccinic resin as claimed in claim 10 and a polyisocyanate component.

15. A composition comprising the binder formulation as claimed in claim 14, wherein the composition is a coating composition, a mastic composition or an adhesive composition.

16. A process for preparing a coating, an adhesive or a mastic comprising applying the binder formulation as claimed in claim 14 to a substrate and drying the binder formulation.

17. The process as claimed in claim 2, characterized in that the alkyl diester is chosen from: dimethyl maleate, diethyl maleate, dipropyl maleate, diisopropyl maleate, dibutyl maleate, di(tert-butyl) maleate, diisobutyl maleate, di(sec-butyl) maleate, dimethyl fumarate, diethyl fumarate, dipropyl fumarate, diisopropyl fumarate, dibutyl fumarate, di(tert-butyl) fumarate, diisobutyl fumarate, di(sec-butyl) fumarate, and their mixtures.

18. The process as claimed in claim 4, wherein z ranges from 1 to 20.

19. The process as claimed in claim 7, characterized in that the molar ratio of the polyol to the diester is less than 0.4/n.

20. The aminosuccinic resin as claimed in claim 10, wherein the amine value is less than 150 mg KOH/g.

21. The aminosuccinic resin as claimed in claim 11, wherein R₅ is a saturated or unsaturated, linear, cyclic or branched, hydrocarbon chain comprising at least 2 carbon atoms.
